(19) United States
(12) Patent Application Publication
(10) Pub. No.: US 2026/0251112 A1
(43) Pub. Date: Aug. 27, 2026

(54) Method and Apparatus for Non-Fossil Fuel Internal Combustion Engine

(71) Applicant: MayMaan Research Inc., Hollywood, FL (US)

(72) Inventors: Yehuda Shmueli, Davie, FL (US); Eitan Shmueli, Aventura, FL (US); Doron Shmueli, Hollywood, FL (US)

(73) Assignee: MayMaan Research Inc., Hollywood, FL (US)

(21) Appl. No.: 19/061,437

(22) Filed: Feb. 24, 2025

(51) Int. Cl. F02M 61/16; F02D 19/06

(52) U.S. Cl. CPC F02M 61/16; F02D 19/06

(57) ABSTRACT

A method and system for operating an internal combustion engine includes a cylinder in an engine block defining therein a cylinder and combustion chamber, at least one piston configured for reciprocation therein, and a crankshaft configured to convert the reciprocal motion of the piston into rotational motion. The combustion chamber is configured to receive a fuel charge of air and liquid fuel consisting essentially of water and a flammable non fossil substance, the ratio thereof is configured to modulate the condition in the combustion chamber. The mixture is ignited to generate a pressure rise against that acts on the piston.

### FIELD OF THE DISCLOSURE

The present disclosure relates generally to internal combustion engines and combustion powertrains. More particularly, the present disclosure relates to a method and apparatus for operating an internal combustion engine operable on a wet-alcohol type comprising combustible and inert elements.

### BACKGROUND OF THE DISCLOSURE

The use of fossil fuels to run engines that are used, for example, in cars and other vehicles, as well as many other engines used for a variety of purposes, is based on a very old concept based on the internal combustion engines developed in the nineteenth century. Despite intense research and development for alternate fuels for the last 50 years, fossil fuel derived from petroleum or natural gas is still essentially the primary source of energy for almost all the internal combustion engines presently in use worldwide.

As a result, the world supply of fossil fuels has been severely depleted creating a shortage, and the price of oil has been climbing for the past 40 years. In addition, such fuels are very polluting, and some suggest that it has either been the primary cause or have contributed substantially to global warming. All these factors led to many efforts to find and harness renewable energy sources other than traditional fossil fuels. Several alternative fuels have been introduced in the past few years to reduce the impact of petroleum depletion, including hybrid cars, electric cars, biodiesel, hydrogen-based cars, etc. However, none of these solutions were effective. One reason for this lack of success is that they require a completely new infrastructure for the production of the engines, as well as the production and distribution of the fuel. Moreover, most solutions proposed so far were incompatible with the existing engines and, therefore. The cost of replacing all the existing fossil burning engines may be so high that it may render any solution based on alternate fuels unacceptable, at least, on a short term basis.

Water as a source of fuel has been suggested by many in the past and many experiments have been conducted testing such systems. The basis of such experiments is the fact that water can be separated into hydrogen and oxygen and the resulting stoichiometric mixture can be fed into an internal combustion engine to generate power. However, past experiments yielded unsatisfactory results. The main obstacle to their success is based on the fact that the energy required to separate the water into its components is much greater than the energy produced by the engine. Hydrogen-enriched fuel mixtures have been developed to improve water-containing fuels. However, the amount of H2 enrichment needed to run a typical automotive engine is too large to make such a system practical.

For example, commonly-assigned U.S. Pat. Nos. 8,869,755 B2, 9,074,555 B2, and 10,436,108 B2, the contents of which are incorporated by reference in their entirety, describe internal combustion engines using a water based mixture as fuel including an ability to export power from the internal combustion engine.

### BRIEF SUMMARY OF THE DISCLOSURE

The present disclosure relates to systems and methods for internal combustion engines. In more detail disclosed is an internal combustion engine having a cylinder, a combustion chamber, and a piston configured to reciprocate therein. A mixture of non-fossil fuel and air can be inducted into the internal combustion engine, compressed and ignited to generate a pressure rise. The internal combustion engine can be configured to capture this pressure rise as mechanical crank work. Importantly, the mixture of non-fossil fuel is selected which can generate a positive input of work to the system, similarly to a mixture of gasoline and air. The combustion results in work which can be captured and converted, for example as power generation or to propel a vehicle.

The apparatus and method described in this disclosure can be adapted to various engine types, including rotary, jet, and piston-based engines, provided they can implement the basic principle of the invention. This principle involves mixing air with a composition of water and a flammable, water-soluble fuel, compressing the mixture to a high pressure to generate heat and create an explosive mixture in a combustion chamber, and igniting the mixture to cause rapid gas expansion and steam formation, thereby generating mechanical power. Notably, the internal combustion engine and method do not require additional fuel sources, such as hydrogen gas, to sustain combustion once ignited. The fuel primarily consists of water and a flammable component, such as alcohol, acetone, aldehyde, Dimethyl Ether (DME), or other renewable, non-fossil fuels that are soluble in water, with the flammable material comprising approximately 10-40% of the fuel mixture by volume. Importantly, the ratio of water and non-fossil fuel can be adjusted to modulate conditions within the combustion chamber. More specifically, the concentration of flammable component in the fuel can be increased or decreased to control the temperature of combustion. Such a control over the temperature of combustion can provide the ability to modulate cylinder temperatures.

In one aspect, the present disclosure provides a method of generating power using a non-fossil-fueled internal combustion engine. The method can comprise of generating power using a non-fossil fueled internal combustion engine; compressing the fuel and air in the combustion chamber to form a compressed air-fuel composition; and while compressing the composition in the combustion chamber, igniting the composition in the combustion chamber to generate power; wherein the air compressed in the combustion chamber is not enriched with hydrogen gas prior to the igniting the composition. The catalyst fuel consists essentially of water and a non-fossil flammable fuel component.

In any implementation of the method, the flammable component can be an organic compound or a combination of two or more organic compounds. The method can comprise compressing the contents of the combustion chamber to a ratio of about 10:1 to 40:1. In any of the methods described herein, the method can include selecting a catalyst fuel and inducting the catalyst fuel into the combustion chamber with the fuel charge that can cause the combustion chamber to reach an equilibrium state and cause the combustion chamber to operate at a predefined temperature, predefined pressure, or both.

In another aspect, the disclosure provides an internal combustion engine for use with only non-fossil fuel. The engine can comprise at least one cylinder having a combustion chamber; a fuel source configured to provide a non-fossil flammable fuel consisting essentially of water and a non-fossil flammable component; a fuel injector configured to selectively deliver the fuel from the fuel source to the combustion chamber; at least one piston disposed in the at least one cylinder, the piston being shaped and dimensioned to move within the at least one cylinder to compress a combination of air and the catalyst fuel; and an ignition device configured to ignite the compressed combination of air and catalyst fuel in the combustion chamber. In any implementation of the engine, the catalyst fuel can comprise about 5% (v/v) to about 60% (v/v) of the flammable component.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The present disclosure is detailed through various drawings, where like components or steps are indicated by identical reference numbers for clarity and consistency.

FIG. 1 is a schematic view of an internal combustion engine depicting a fuel source coupled to the internal combustion engine configured to supply a combination of water and a non-fossil fuel in accordance with one aspect of the present disclosure.

FIG. 2 is a sectional side view of some elements of an internal combustion engine constructed to operate on the water and non-fossil fuel in accordance with another element of the present disclosure.

FIG. 3 is an alternative sectional side view of the elements of FIG. 2 in continuing accordance with the present disclosure.

FIG. 4 is a schematic view of an internal combustion engine which comprises a homogeneous charge compression ignition configured for operation on non-fossil fuel in accordance with one aspect of the present disclosure.

FIG. 5 is a flow chart of a method for operating an internal combustion engine configured to use a non-fossil fuel in accordance with one aspect of the present disclosure.

### DETAILED DESCRIPTION OF THE DISCLOSURE

Again, the present disclosure generally relates to internal combustion engines configured to operate on non-fossil fuel and methods for operation thereof. The method may involve transferring a fuel, such as a non-fossil-based fuel, into the engine's combustion chamber. This fuel can be delivered along with air in a ratio designed to generate a pressure increase upon ignition. Additionally, the method may involve injecting a fuel mixture primarily composed of water and non-fossil fuel into the combustion chamber. In certain embodiments, the air-fuel mixture can be compressed within the combustion chamber by a piston. It is anticipated that during this compression process, the fuel will be ignited to produce a pressure rise against the piston, timed to occur when the piston reaches an optimal crankshaft position.

The engine itself can consist of at least one cylinder, which remains in fluid communication with a fuel source that is non-fossil or non-petroleum based. It may also include a fuel injector specifically designed to introduce the water and non-fossil fuel mixture into the combustion chamber. The engine is engineered to compress the combined air, water, and non-fossil fuel components and to ignite this mixture through an ignition source, such as a spark plug. Moreover, the ratio of air, water, and non-fossil fuel can be adjusted to fine-tune the combustion characteristics and optimize engine performance. Specifically, the degree of disassociation can be controlled by way of adjusting the ratio of the water, air, and non-fossil substance.

### Internal Combustion Engine Assembly

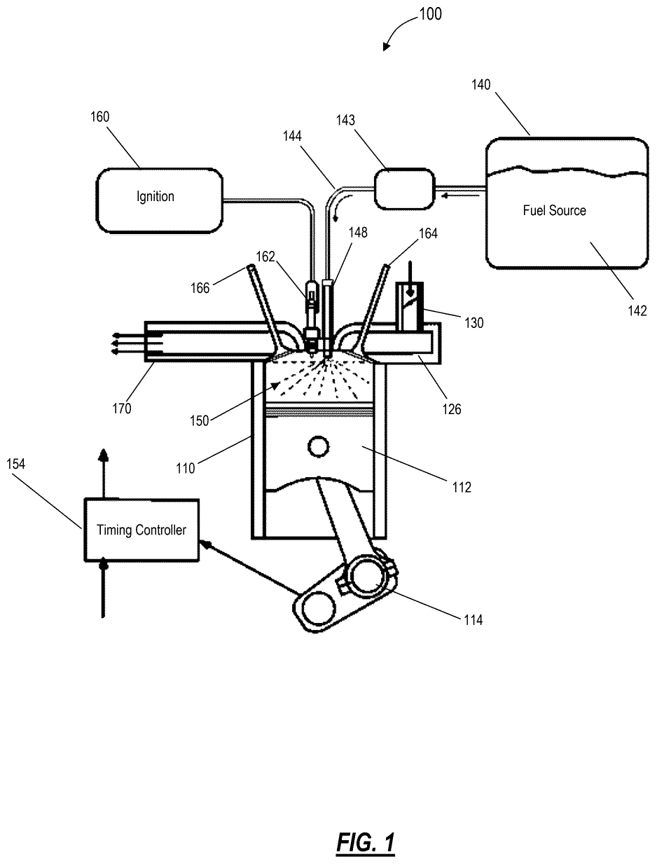

Turning now to FIG. 1, a first embodiment of an internal combustion engine in accordance with one aspect of the disclosure is shown and described. FIG. 1 shows an engine 100 constructed in accordance with this disclosure. The engine includes a cylinder 110, with a reciprocating piston 112 driving a shaft (not shown) through a linkage 114. For example, an experimental engine 100 was constructed by the inventors, by modifying a generic and commercially available 400 cc Diesel engine. The engine 100 further includes a conventional air intake manifold 126 with an air intake 128 and a butterfly-type adjustment valve 130, an intake valve 164, an exhaust valve 166, an exhaust manifold 170 and a fuel injector 148. The fuel injector 148 can be located at different portions of the engine, such as in the intake manifold 126, directly in the combustion chamber, or connected to a throttle body. The fuel injector 148 can be a mechanical injector, an electronic injection, a piezoelectric injector, a unit injector, or any other type of injector. The fuel injector 148 can be adapted to provide fuel at a substantially higher pressure than the working pressure of the engine.

In a conventional four-cycle Diesel engine, air is induced in through intake manifold 126 into the combustion chamber 150 of the cylinder 110 while the piston 112 moves down as a result of the negative pressure created therefrom. The intake valve 164 then closes, the piston 112 moves up and a Diesel fuel is injected by the injector 148 into chamber 150. The piston 112 compresses the mixture of air and fuel and combustion occurs. The piston 112 then moves down to drive the shaft and moves up again, and the exhaust valve 66 opens exhausting the remaining gases through the exhaust manifold 170. The intake manifold 126 also receives ambient air through the air intake 128 and, as will be discussed in more detail below, the amount of air flowing into the combustion chamber 150 is controlled by the valve 130. The engine 100 further includes a fuel tank 140 holding a fuel 142. The fuel 142 is provided through a tube 144 by pump 146 to the fuel injector 148.

The fuel in the fuel tank consists essentially of water and a flammable component soluble in water. More specifically, it is believed that the flammable component should be 30% soluble in water by volume. The flammable component may include, alcohol, acetone, aldehyde, dimethyl ether (DME), and other similar, preferably non-fossil substances or mixtures thereof. In a preferred embodiment, the flammable component is an alcohol selected from isopropyl alcohol, isobutanol, propyl alcohol, butyl alcohol, ethyl alcohol, methyl alcohol, long chain alcohols, and a mixture of any two or more of the foregoing alcohols. In certain implementations of the method, the flammable fuel component is one of formaldehyde, acetaldehyde, butyraldehyde, benzaldehyde, cinnamaldehyde, tolu aldehyde, furfural, retinaldehyde, glyoxal, malondialdehyde, succindialdehyde, glutaraldehyde, paraldehyde or mixtures thereof. Alternatively, the flammable component is one of formaldehyde, acetaldehyde, butyraldehyde, benzaledehyde, cinnamaldehyde, tolualdehyde, furfural, retinaldehyde, glyoxal, malondaldehyde, succindialdehyde, glutaraldehyde, phtalaaldehyde or mixtures thereof. The concentration of the flammable material can be in the range of 5%-40%, and preferably 10%-35%. The inventors have found that, in particular a mixture of about 70% water to 30% isopropyl alcohol is particularly advantageous in that it provides a favorable cost vs. performance characteristics.

The fuel 142 from the fuel tank 140 is provided to the fuel injector 148 by pump 143 at a pressure in the range of 200-3,000 PSI. In one embodiment, the fuel is injected at a pressure of about 2000 PSI. The main fuel used in such known engines was a fossil fuel. In the present engine 100, the fuel 142 is essentially an aqueous mixture of a flammable material, preferably with no fossil components. The engine 100 also includes a high-energy ignition system 160 providing electrical current to an ignition device 162 (such as a standard spark plug) extending into the chamber 50 as shown.

The system 160 and ignition device 162 (i.e., the spark plug) are conventional components used for internal combustion engines using gasoline as fuel. In some aspects, the ignition device can be a glow plug or a plasma based ignition device. In some aspects, the high energy ignition system 160 can be a capacitor discharge ignition (CDI), a coil-on-plug (COP), an ignition coil pack, a plasma ignition system, a multi-spark ignition, or a transistorized ignition system.

A timing controller 154 (typically including a microprocessor—not shown) receives input timing signals and a load signal indicative of the load on the engine 100. The input timing signals are typically derived from the position of the crankshaft (not shown). The load signal is indicative of the load on the engine 100 is derived using conventional techniques. In response, the timing controller generates output timing signals that control the operation of ignition device 162, fuel injector 148, and air intake valve 130, valves 164 and 166 open and close it controlled by a traditional camshaft (not shown). Importantly, the engine 100 operates at a very high compression ratio. Typically, a conventional combustion engine operates at a compression ratio of around 15/1 to 18/1, except for some very special engines, such as the engines used car racing. The present disclosure can be constructed to operate in the range of 10/1-40/1, and preferably in the range of 25/1-35/1 or in the range of 15/1 to 30/1. An optimal compression ratio is about 30/1. This high compression ratio can be achieved by shaping the head of the top of the piston to reduce the volume of the combustion chamber.

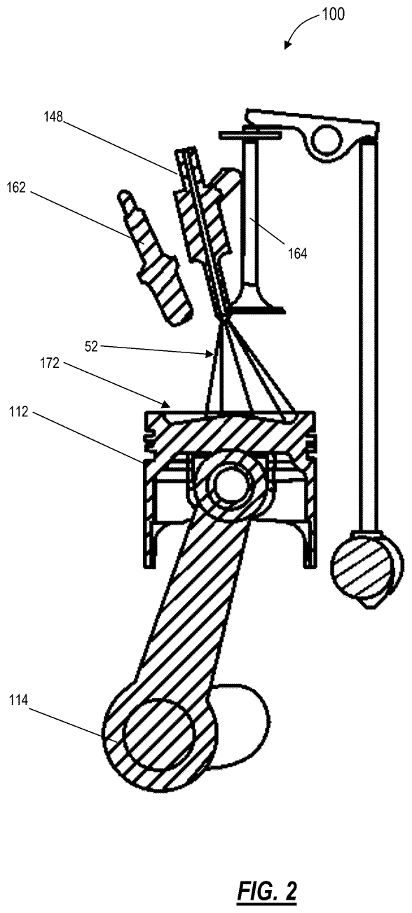

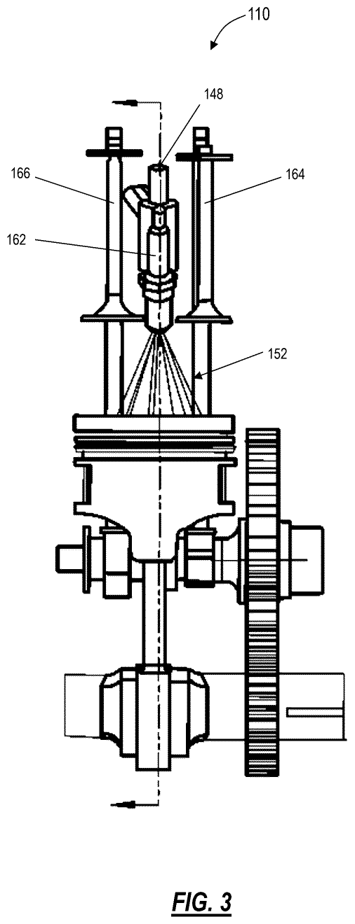

Turning now to FIGS. 2 & 3, an example aspect of the internal combustion engine configured for wet alcohol fuel is shown and described. For example, as shown in FIGS. 2 and 3, the top surface of the piston 112 can be shaped with an indentation 172. The indentation can be a valve relief. In other aspects, the indentation has a predetermined size and shape selected to provide the required compression ratio and to generate turbulence in fuel plume 152. For this purpose, the indentation 172 is placed so that as the piston 112 is moves upward toward the top of the cylinder and the plume of fuel 152 is released by the fuel injector 148, the plume 152 using the shape of the surface of the indentation causing it to swirl. The exact shape of the indentation can be determined by the fluid dynamics of the fuel charge. In some aspects, the indentation 172 can be cast into the piston 112 or machined into an existing piston 112.

In one embodiment of the disclosure, a single plume 152 is released by the fuel injector 148 in every intake cycle. In an alternate embodiment, 1-5 plumes are released, depending on several variables, such as the type of fuel being used, the load on the engine, ambient temperature, etc. If more than one plume is released, the first plume is released much earlier than the combustion point, to enrich the vapor mixture in the chamber 150, and the other plumes are released just prior to combustion, as well during combustion. In many aspects, the plume 152 can define a geometry which can be used to configure to dimensions of the indentation 172.

The engine 100 operates in a manner similar to a standard four-cycle internal combustion engine but with some important differences. During the intake cycle, as the piston 112 moves downward, the valves 130, 124 and 164 open to allow air to enter into and mix in chamber 150. Next, during the compression cycle, valve 164 closes, and the piston 112 moves upward compressing the gases in chamber 150. At a predetermined point, e.g., typically at around 120 degrees btdc (before top dead center), the plume 152 of fine droplets of fuel is injected into the chamber 150 by fuel injector 148 and it mixes with the air/fuel mixture. The piston 112 keeps moving upward compressing further to a very high pressure and temperature which creates a very combustible content inside the combustion chamber 150. The mixture in chamber 150 is ignited (typically at top dead center) by ignition device 162 (i.e., the spark plug) or other ignition device causing combustion that converts the mixture within the chamber 150 into very hot and highly pressurized gases including steam. These gases force the piston 112 to move down in the conventional manner. The next upward movement (exhaust cycle) of the piston 112 causes the remains of the combustion to be exhausted through the exhaust manifold 170. These remains consist mostly of water vapor.

Surprisingly, at substantially no load, it was found that engine 100 can run at 2500 RPM indefinitely, even when the air intake adjustment valve 130 is closed, and therefore almost no air (and, very little oxygen) is provided to the engine. Apparently, during the compression and/or explosion stages at least some of the water from the fuel disassociates into H₂ and O₂ and provides the oxygen necessary for the combustion. The remainder of the water is apparently turning into steam. As the load on the engine increases, the valve 30 should be opened; otherwise the engine slows down and can stop running. The amount of air being introduced through valve 130 is dependent on the load on the engine and, since apparently the air is not needed for the combustion, it is believed that, as the load increases, in order to maintain RPM and produce power against the load, a higher torque is needed, the air is needed as a working gas that create a higher combustion pressure which in turn create a higher torque when it is pushing the piston down.

In an example aspect, the operating parameters of the engine can include a compression ratio of about 30:1, a fuel water ratio of about 70% fuel and 30% water, an air induction of about 0-50 l/min, and a fuel injection pressure of about between 200-3000 PSI. Notably, this range could be anywhere from 200 to 10,000 PSI. The techniques shown can be easily applied multiple cylinders, in addition to a regular piston or a rotary engine, the disclosure can be developed turbine and jet engine as well. For example a conversion of a Diesel based engine is fairly simple, only the head is needed to be modified in order to introduce the ignition device, a high power ignition system, the shape of the piston and the combustion chamber to allow a suitable compression ratio, making this solution an inexpensive and simple to introduce to the market place. Since water is practically available in any fuel station, no main infrastructure needed to be created. The flammable component can be automatically mixed with clean water and fed into the fuel tank of the vehicle.

It is envisioned that several aspects of the present disclosure can be incorporated into a wide variety of engine operation cycles, including two-stroke, four-stroke, diesel, six-stroke, or the like. Notably a person of ordinary skill in the art would easily understand that modifications based on the specific engine architecture are readily feasible. For example, a two-stroke engine would require modifications to the porting and port timing similarly to modifying the valves or valve timing on a four stroke.

### Homogeneous Charge Compression Ignition

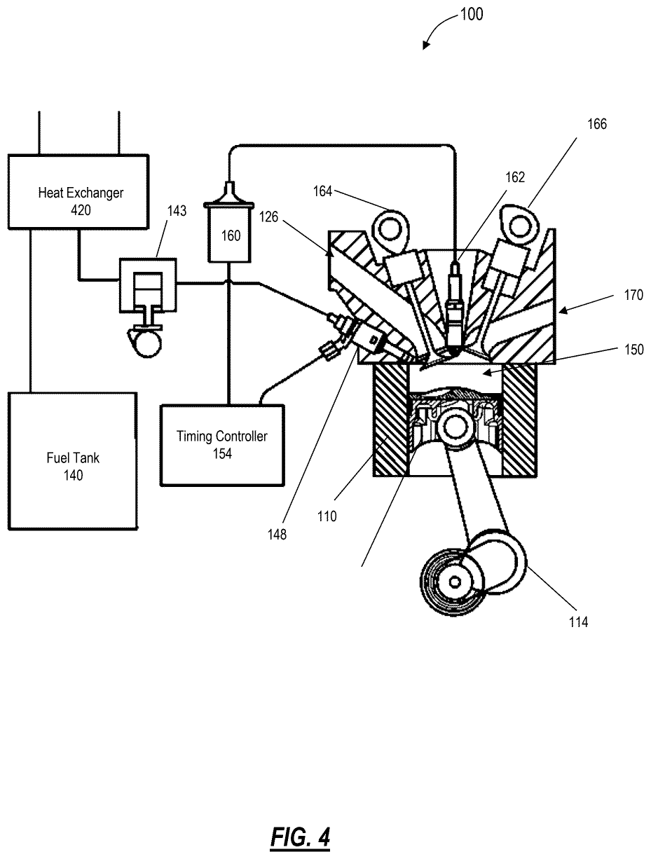

Turning now to FIG. 4, an alternative embodiment of the engine is shown and described. In some aspects, the internal combustion engine can operate with a homogeneous charge compression ignition scheme. More generally, FIG. 4 depicts an HCCI type internal combustion engine The present invention discloses an aliphatic type alcohol component (methanol, ethanol, propanol, isopropanol or butanol) in combination with a water component. The relative percentages of the alcohol and water components are provided in an inverse range of between 20% to 80% by volume of the fuel mixture and is employed in any type of higher compression cycle (HCCI) for a power train operation, typically with spark or glow plug assist, for providing improved fuel injection and valve timing aspects in combination with oxygenated hydrocarbons (alcohol fuel) with significant water added for achieving a varied range of compression ratios. In this manner, the present invention seeks to optimize cylinder pressure for longer durations (i.e. across greater crank angles) for achieving improved torque characteristics, this also referred to as brake mean effective pressure (or BMEP).

The engine or powertrain applications described herein may include but are not limited to a typical 4-cycle combustion process, and additionally envision other cycle processes (2-cycles or multiple-cycles) having a similar combustion process with cycle variations. Additional features include modifying the ignition timing (also termed timing advance) of the combustion cycle within the chamber. As the combustion pressure curve is optimized to the crank rod angle, the initiation of combustion is the main timing factor, such that at low RPM (1000-2000 RPM) it is fairly easy to control and optimize where an advance ignition of 30-degree BTDC (Before Top Dead Center) is sufficient. In contrast, at higher RPM

In an additional embodiment, the single spark plug utilized with the individual cylinder is substituted by a pair of spark plugs for increasing power output, such as at engine speeds greater than 2500 rpm. The plugs are strategically located from offset angular directions and, in operation, increases the power output by around 7% at engine speed higher than 2500 RPM, which is significant in larger bore engines where the combustion chamber is bigger. Other features include the use of DME (Dimethyl Ether Ethanol) in the wet fuel mixture, this performing similarly to Ethanol it performs and produces similar power and efficiency. DME is now produced from captured CO2, therefore the use of this fuel in the present system creates a positive effect on global warming concerns, given use of DME from captured Co2.

Elevated heating of the fuel mixture increases efficiency, as it results in more complete combustion of the hydrocarbons in the mix. Specifically, heating of the fuel above the Ethanol boiling point (above 78 degrees C. at no atmospheric pressure), combined with increasing the fuel pressure (such as from approximately 60 psi in normal fuel injector situations to above 2000 psi post fuel pump), results in the wet alcohol (such as ethanol/alcohol) mixture not boiling in the fuel system and only when sprayed to the chamber. The result of this is render improved atomization such heating of the fuel is done without any heat source, we use a heat exchanger where the coolant fluid is flowing on one side and the supply fuel is flowing through the other side.

The engine of the present invention also includes a method whereby it initiates and controls the Start of Combustion (SOC) and which can incorporate a hot initiation source again including, but not limited to, a spark plug or glow plug in any configuration. The engine can contain either a boosted configuration (not limited to either an engine-driven supercharger or an exhaust gas-driven turbocharger) or can be provided in a naturally-aspirated (NA) configuration.

The combustion process is controlled for SOC via the initiation device, and results is a very low overall NOx emission similar to that found in HCCI-type combustion. The high percentage of water in the alcohol/water mix tends to prolong the cylinder pressure which leads to the indicated mean effective pressure (IMEP) to be increased, leading to a higher torque (improved Brake Mean Effective Pressure—BMEP) of the engine via the longer pressure pulse attained during the period of preferred mechanical advantage of the crank-arm of the engine.

The above-described benefits and advantages occur without increases in the friction mean effective pressure (FMEP) or the pumping mean effective pressure (PMEP). In this manner, the specific efficiency of the engine is high, due in part to high compression ratios achieved, as well as including properly chosen valve timing events and proper variation in SOC events based on temperature, speed and load. With regard to exhaust emissions, other exhaust constituents, such as unburned fuel are consistent with HCCI-type combustion and can be controlled via traditional after-treatment means.

Other features include the use of DME (Dimethyl Ether Ethanol) in the wet fuel mixture, this performing similarly to Ethanol it performs and produces similar power and efficiency. Traditionally, dimethyl ether (DME and CH₃OCH₃) is generally produced by dehydration of methanol. Also, elevated heating of the fuel mixture increases efficiency, as it results in more complete combustion of the hydrocarbons in the wet alcohol mixture. Specifically, heating of the fuel above the Ethanol boiling point (without limitation above 78 degrees Celsius), combined with increasing the fuel pressure (such as from approximately 60 psi in typical fuel injector situations to above 2000 psi post fuel pump), results in the wet alcohol (such as ethanol/alcohol) mixture not boiling in the fuel system, and until sprayed into the chamber at which point it boils just prior to being combusted and as it reverts back to atmospheric pressure.

The combined heating and pressurization of the fuel results in improved atomization, with such heating of the fuel capable in one application of being accomplished without application of any extraneous heat source (with heating of the wet alcohol mixture to the desired temperature resulting from the pressurization alone of the fuel). By way of brief explanation, compression of the fluid by itself increases the momentum of the fluid molecules and, thus, the kinetic energy. As a result, the molecules become faster and the temperature consequently rises with higher pressurization resulting in higher temperatures.

Alternatively, a supplementary and separate heat source can be supplied to the fuel either during or post pressurization at the heat pump (again such also being understood to be additional or supplemental to the inherent heating aspect involved with pressurizing the fuel mixture). Supplemental heating can again include utilization of a convective heat transfer process utilizing the inflow 20 and outflow 21 lines of FIG. 1 extending to and from the engine (not shown) when and where needed and in order to achieve the desired temperature increase of the compressed wet fuel mixture above its normal atmospheric boiling point. Such supplemental heating can also include provision of other separate and non-engine related heating components known in the technical art (again such as built into the fuel pump or at a pressurized downstream location relative thereto with or without the application of extraneous heat sources for elevating the temperature of the wet fuel mixture to in excess of seventy eight degrees Celsius).

Alternatively, the heating of the wet alcohol fuel mixture can be accomplished downstream from the fuel being pressurized in a fashion which is beyond a normal boiling temperature of the mixture at atmospheric pressure, this again in order to prevent boiling prior to the pressurized and heated fuel being communicated through the high pressure fuel line and sprayed into the combustion chamber by the fuel injector. Without limitation, it is also understood that the arrangement of FIG. 4 can be utilized in this situation and in which the elevated heating of the wet fuel mixture (such as to temperatures in excess of 78 degrees C.) is facilitated at a sufficient pressure to prevent atmospheric pressure inducing boiling prior to the heated fuel being sprayed into the combustion chamber.

As is further shown, higher engine RPM corresponds to an earlier injection and, when manifold pressure is high (i.e., high load-less vacuum) the injection is delayed. In this manner, the injection timing is crucial to maintain high torque and efficiency in all speed load combinations and to achieve a stable and efficient combustion based on each of speed, load and temperature variables.

Other and additional features associated with the present invention include each of the following: pressure vs. crank angle timing sync, thus generally the start of ignition should start at 40-45 degrees before top dead center, and this should be always controlled by the ECU, as low RPM and High RPM requires different timing.

### Hot Intake Air:

When using a turbocharger in the system, it has been found that no intercooler is needed, actually the efficiency is increased without one as the intake air is heated up by the turbocharger which help for a more homogenized combustion.

### Long Stroke:

Due to the nature of a longer duration combustion, achieving a longer stroke has been found to better utilize the pressure characteristic, and to yield more power, it will also allow for a very late exhaust valve opening in relation to the piston position on the way down from the TDC position.

### Using Heat:

A direct correlation has further been identified of the heat vs. efficiency and performance. While this also occurs in other combustion methods, the ability of the present invention to delay/raise fuel detonation, results in the ability to raise the working temperatures of the engine without the occurrence of engine knock or run-on, with the result that all thermal barriers which help retain the heat within the engines will contribute to a conversion of a wasted heat to increase in performance and efficiency.

### Hot Plug:

Experimentation has found that a hot rated spark plug will provide better output, as it acts as a spark/glow plug combination.

### Low RPM.

Other observations of the present invention have found the ability to establish high torque at low to mid RPM, which is atypical for conventional engines of comparable size. In such instance, the engine is working and making about 85% of its maximum torque even at a rating of 1000 RPM.

Given the above description, objective attained by the present invention include a steam-induced late cycle pressure increase associated with a high percentage of water in the alcohol/water mixture operating to prolong the cylinder pressure which leads to the indicated mean effective pressure (IMEP) being increased, this leading to a higher torque of the engine. The late cycle pressure increase results from delayed Start-of-Combustion (SOC) in combination with the effect of in-cylinder conversion of the high water-content fuel to steam, this leading to an improved indicated mean effective pressure (IMEP). This effect again results from the longer pressure pulse during the period of preferred mechanical advantage of the crank-arm as referenced in the drawings and which occurs without increase in the friction mean effective pressure (FMEP) or the pumping mean effective pressure (PMEP), collectively resulting in a net BMEP benefit.

The internal combustion process with wet-alcohol fuel as described is envisioned to operate within a relatively high compression ratio of between 10:1 and 25:1 determined by the type of engine being configured, wherein the configuration is either naturally aspirated (NA) or boosted. The present invention further contemplates lower compression ratios used for boosted configurations and higher compression ratios for NA engines.

The internal combustion process with wet-alcohol fuel as described includes the capability to operate under transient conditions for both a) speed and b) load of the engine output torque. This is due to a combustion process that contains the individual claims embodied in this patent and in which the powertrain includes at least a multi-speed transmission and a final drive in any configuration. The ability to control the engine for transient operation is comprised in the proper use of all the claims of this patent.

As described, pre-heating techniques contemplate heating the fuel, such as to a temperature of approximately 60-80 degrees Celsius (C) and, with reference again to FIG. 4, may include without limitation passing the fuel initially through the electric heater during warm-up and utilizing the waste-engine heat after operating temperature is achieved.

Other features include controlling of the air/fuel ratio (also AFR) through a control system containing a Mass Air Flow (MAF) sensor, a Lambda Sensor or Sensors and a digital Electronic Control Unit (ECU). In one non-limiting variant, the AFR value is controlled between 13:1 and 16:1. Furthermore, under transient operating conditions the enrichment may go to Lambda 0.95.

Fuel injection timing aspects include the internal combustion process with wet-alcohol fuel being programmed into the digital ECU. Under warm-up conditions (typically in a range of 60 degrees C. to 100 degrees C.) the fuel is injected late, or near the end of the intake cycle (^{~}180 degrees Before Top Dead Center (BTDC)). At operating temperature, the fuel is injected early at the beginning of the intake cycle (^{~}360 degrees BTDC). Under heavy load at any engine speed the fuel injection event is between 320 degrees and 250 degrees BTDC. At light load and high speed the injection events are very early at 420 degrees to 360 degrees BTDC. The majority percentage of water to alcohol can further include any relative percentage range of up to 80% water corresponding to a decreasing range down to 20% alcohol.

The present invention provides valve timing features in which the combustion techniques can be applied to engines having any valve train actuation type from an in-block single mechanical camshafts to single or multiple over-head mechanical camshafts and to advanced valvetrain actuations systems such as hydraulic, pneumatic or electromagnetic completely-variable valve-actuation systems. The mechanical camshaft actuation system also includes techniques for independent intake and exhaust cam phasing when available or for single mechanical camshaft engines, this including a reasonable compromise for valve timing and overlap.

Specific valve train actuation events can also include valve actuation based on speed and load variables. At high speed and low-load the intake valve closing (IVC) event includes a late IVC and, for high-speed and high-load conditions, the IVC event is performed early or at a more traditional timing. Valve overlap timing also contemplates, under high load, an increasing overlap, with absence of an overlap at lower loads. Depending on the valve actuation technique employed, the control of these parameters includes a cam phasing device controlled by the digital ECU or has the potential in more sophisticated and future actuation devices that may be completely performed by the digital ECU. Reference again is made to FIG. 6 which shows the typical relationships between valve events and speed/load.

### In-Cylinder Conditions

It is envisioned that any of the following method can be implemented in any internal combustion engine or heat engine, in which the principals of the object of the disclosure are applicable notwithstanding the illustrative examples describing use in reciprocating piston engines. In general, the disclosure provides a method for operating an internal combustion engine with a non-fossil fuel which includes water and a flammable component which is not derived from petroleum. The inventors observed that, through the control of the ratio of water and flammable component in the non-fossil fuel, the in-cylinder parameters could be controlled. Primarily, the in-cylinder temperature can be adjusted based on the amount of flammable component in proportion to water in the non-fossil fuel.

In past work, the inventors included a hydrogen source, for example brown gas. The hydrogen source has also been provided in mixtures which, for example only, have included diatomic Hydrogen and Oxygen. More generally, in past embodiments, hydrogen was always added in addition to the fuel in order to increase either the reactivity, combustion efficiency, or other parameters of the reaction in the combustion chamber which can affect the pressure rise. In prior works, it was found that the engine required about ½% to 2% of Hydrogen by volume. In other works, It was found that the process worked well when a volume of 2 ml of the H₂/O₂ gas mixture was provided to the engine for every revolution. Since the engine is a 400 ml (or 400 cc) engine. The amount of H₂/O₂ provided for each revolution is about ½%-2% of H₂ by volume. In summary, the prior art requires the inclusion of some Hydrogen source to achieve the required in-cylinder conditions. Obviously, this can present critical challenges with regards to fueling, because the availability of Hydrogen gas is currently limited at fuel stations.

Disclosed herein is a method of preparing a fuel charge for use in an internal combustion engine which does not require supplemental Hydrogen gas to be provided by a means. The hydrogen can be sourced from the water content of the non-fossil fuel through the preparation techniques and ratio of fuel delivery. The method can include the conditioning of the non-fossil fuel to better increase the likelihood of dissociation.

While presently the exact phenomenon occurring is not completely understood, it is believed that that proportion of the water component is being dissociated or cracked into Hydrogen and Oxygen. Notably, the inventors have discovered that the degree of disassociation can be controlled by the fueling parameters and conditions provided to the engine. Such disassociation, which results in Hydrogen and Oxygen gas being present in the combustion chamber prior to ignition replaces the need in the art to provide a Hydrogen source. As discussed above, the fuel is preferably a solution of water and a flammable liquid substance. In addition an additive can be added, such as a non-corrosive material that increase the conductivity of the water at high pressure during combustion thereby helping the separation of the water to H₂/O₂.

### Control of Dissociation

One aspect of the present disclosure involves techniques for methods of operating an internal combustion engine on wet-alcohol or non-fossil fuels. As noted, the water component of the non-fossil fuel is operable to disassociate or crack in the cylinder prior to the ignition event. As used herein, the term disassociation or cracking generally refers to the splitting of a molecule, for example water, into a smaller molecule, atoms or ions. In some aspects, the process can be reversible. As know, water tends to crack into H₂ and OH radicals, because removing one Hydrogen nucleus can leave a negatively charges hydroxide ion. Sometimes it is possible to remove a second positively charged nucleus from the now double-negative oxygen, but this is otherwise unlikely and comprises a small proportion of the cracked molecules because of the increasingly strong electrostatic attraction. In other words, the majority of the cracked water likely results in H₂ and OH radicals. The method of the present disclosure involves the utilization of the H₂ and OH in the combustion chamber reaction.

One aspect of the present disclosure involves manipulating the compression ratio of an engine to encourage the disassociation of the water component in an engine utilizing non-fossil fuels that comprise water. In an internal combustion engine, the increased temperature and pressure from the higher compression ratio can promote the thermal disassociation of the water component of the fuel. The compression ratio refers to the ratio between the volume of the combustion chamber and the volume of the sum of the combustion chamber and cylinder. Essentially, the increased compression ratio increases the likelihood of thermal dissociation. Therefore, an aspect of the method can involve increasing the compression ratio such that the result is a fuel charge that supplies sufficient H₂ through the cracked water. The inventors have found, without limitation, compression ratios of about 40:1 can result in substantial amounts of H₂ being to ameliorate the reliance on externally provided H₂. More specifically, increasing the compression ratio in the engine can impact the thermodynamics and kinetics of the chemical reaction prior to the combustion event. The compression stroke in the engine is approximately an adiabatic processing, meaning there is minimal heat exchange with the surrounding during rapid compression. Under such conditions, the relationship between temperature and pressure can be governed by the ideal gas law.

As the compression ratio is increased, the pressure within the combustion chamber prior to the ignition event increases. Notably, such high compression ratios are achievable because of the water content of the fuel. The water content has an indirect impact in the global cooling of the combustion chamber which can allow higher compression ratios without causing knocking. While this does not directly cause the dissociation, it allows for more aggressive engine tuning which can potentially lead to higher compression ratios and the later increase in cracking. Therefore, one aspect of the disclosure include adjusting the water content of the fuel to maximize or increase compression ratio.

One aspect of the invention involves manipulating the compression ratio to encourage the formation of the cracked radicals (H₂ and OH). It has been found that compression ratios of about 40:1 can achieve such effect. The water dissociation is a thermally activated process and therefore requires the high temperatures which result from the increased compression ratio. Notably, the use of such a compression ratio to crack water is not found in the art, as few internal combustion engines are able to operate on compression ratios past 18:1. The key reactions which the method manipulates through the increased compression is, without limitation, as follows:

$$H 2 O \to {H}_{2} + \frac{1}{2} {O}_{2}$$

$${H}_{2} O \to H + OH$$

In some aspects, the method can comprise manipulating the ratio of water and flammable components in the fuel to produce steam during the combustion. For example, the method can comprise adjusting the ratio such that the steam generation is favorable to promote cracking. During the combustion of the non-fossil fuel, a substantial portion of the water is heated to form steam. The amount of water that is converted into steam is dependent on the latent heat of vaporization of the water and the quantity of water in the fuel mixture. Therefore, one aspect of the present disclosure involves selecting or providing a ratio of water/flammable component, for example a water/alcohol ratio to the engine which generates a volume of steam during the combustion reaction which promotes the cracking of the water into H₂ and OH radicals which can participate in the combustion. Essentially, combustion can take place in two stages, a first stage which can convert the water into steam and a second phase wherein the steam is cracked and the radicals from the steam participate in the combustion reaction. Some aspects of the disclosure provide adjusting the ratio of water/alcohol to actively control the steam content. The control of the conversion can be monitored by monitoring engine performance parameters, such as in-cylinder pressure, cylinder temperature, and emissions species because the formation and participation of the radicals from the cracked water content effect the combustion reaction. For example only, the higher the concentration of radicals can result in a more efficient combustion and form fewer emissions or pollutants.

Essentially, the method can involve adjusting the water ratio in the fuel to manipulate the superheating of the steam either before or during combustion. In some aspects, the water can be superheated prior to the combustion reaction, or partially heated from the increased compression ratio. One aspect of the invention relates to the steam reforming, wherein the water in the fuel mixture is superheated before the combustion event which can assist with the cracking when mixed with alcohol in high temperature zones (i.e., the combustion chamber). One aspect of the present disclosure can include modifying an engine to facilitate the formation of high temperature zones which can assist in the steam reforming or cracking of the water.

The kinetics of the reaction are crucial in the tuning of the engine to manipulate the thermal cracking of the fuel during the cycle. Although increased pressure doesn't thermodynamically favor dissociation, the higher temperatures resulting from increased compression dominate the system, pushing the reaction toward dissociation purely through thermal excitation. In practical engine scenarios, the extremely short resonance time of fuel-air mixtures in the combustion chamber means that the system is rarely in thermodynamic equilibrium, and the kinetic effects (temperature-driven dissociation) become dominant. The role of the high pressure/high temperature conditions on the reaction rate of the radical formation are critical as they are heavily dependent on temperature and pressure according to the Arrhenius equation as provided:

$$k = {Ae}^{- {E}_{a} / RT}$$

Therefore, it can be seen that increasing the temperature exponentially increases the reaction rate by decreasing the effective activation energy barrier, Eₐ. Thus, the dissociation of water becomes kinetically favorable under the elevated temperatures resulting from high compression ratios, even if thermodynamic equilibrium doesn't fully support the dissociation at lower pressures. Importantly, the methods described herein tend to produce a result that is not expected.

More generally, increasing the compression ratio raises the temperature and pressure in the combustion chamber, pushing the conditions closer to those required for water dissociation. The elevated temperature has a more pronounced effect on the dissociation kinetics, encouraging partial water dissociation (into hydrogen and oxygen or hydroxyl radicals), which in turn enhances combustion efficiency. This is a thermally driven process where the benefits of dissociation are realized through the energy released from hydrogen combustion, even though full dissociation requires extreme temperatures that are typically beyond conventional engine capabilities.

Therefore, the water content of the wet-alcohol based non-fossil fuel is critical in enhancing combustion through the manipulation of the in-cylinder conditions. More specifically, the ratio of the water content can be adjusted to manipulate the in-cylinder conditions. The water/alcohol ratio can be manipulated to increase the formation of active radicals, (e.g., H, OH) under high temperature conditions. However, the efficiency of this process depends heavily on the water content of the fuel mixture and the compression ratio of the engine. Too much water can reduce combustion efficiency, while too little water may not significantly enhance radical production. One aspect of the present disclosure proposes a method to dynamically control both the water content in the fuel mixture and the compression ratio of the engine to optimize the production of radicals like H and OH during combustion. The method aims to maximize the efficiency of engines using water-alcohol fuel blends, reduce emissions, and enhance power output through the formation of the radicals without the need of added Hydrogen gas.

One aspect of the invention pertains to the modulation of the water content of the fuel mixture based on operating conditions (e.g., engine load, temperature, engine speed, etc.) while simultaneously adjusting the compression ratio and/or fuel mixture to optimize the formation of radicals. The manipulation of the compression ratio can be achieved statically, wherein the architecture of the engine is modified for a single compression ratio or dynamically, through a mechanical means to adjust the actual working volume of the cylinder or increasing the boosted pressure. For example, the engine could be equipped with a force induction mechanism, such as a supercharger or a turbocharger. Importantly, the forced induction mechanism can increase the dynamic compression ratio of the engine, which is the actual experienced compression ratio. For example, a turbo with a controlled wastegate can be manipulated to supply higher boost pressure which would increase the effect cylinder pressure prior to and after the combustion event. The manipulation of the cylinder pressure would have substantially the same effect as increasing the compression ratio on the formation of radicals. The present disclosure can provide manipulating a mechanical or electrical control system that actively adjusts these parameters. Moreover, the water and the alcohol fuel could be held in separate tanks and provide variable flow therefrom into an accumulator or directly to the injector to modulate the water/alcohol ratio. The present disclosure contemplates other methods of controlling the formation of radicals, including but not limited to: plasma assisted ignition, which involves the use of a high energy or plasma based ignition system to generate high energy ions in the combustion chamber which can encourage the formation of radicals at lower in cylinder temperatures, high-temperature catalysts, such as coatings, for example cerium oxide, Platinum, or Nickel, or advanced EGR recirculation techniques which can reintroduce radicals which have not participated in the combustion reaction back into the cylinder.

### Engine Emission Regulation

One aspect of the present disclosure involves methods for the reduction of emission species in engines configured to operate on water/alcohol fuels. Increasing environmental pressure is resulting in the development of alternative power sources. For example, EVs are becoming increasingly popular in order to comply with increasingly strict regulations. However, the shortcomings of EVs, such as the decreased range and increased cost make them impractical in certain situations. Therefore, development on internal combustion engines continues. Alternative fuels, which can be utilized in existing internal combustion engines are increasingly popular to increase the effectiveness of fleet conversion. A general aspect of the present disclosure involves a method for operating an internal combustion engine to reduce engine emissions.

In one aspect, the present disclosure provides a method for reducing certain engine emissions through the controlled induction of a non-fossil fuel which consists of water and a non-fossil flammable component. The pathways of emission species formation are complex; various types of engine emissions can form from conflicting mechanisms. For example, higher in-cylinder temperatures can increase the formation of NOx emissions while decreasing the formation of unburnt hydrocarbons, because the formation of NOx is dominated by the in-cylinder temperature.

The present disclosure provides a method including the use of an alcohol-based fuel. Notably, alcohol has fewer carbon atoms when compared to gasoline or diesel which can directly decrease the formation of Carbon Dioxide per unit of energy produced. Further, because alcohol carries oxygen to the reaction, there is often a more complete combustion with such fuels. Higher compression engines typically lead to increased combustion temperatures and therefore elevated Oxides of Nitrogen emissions (NOx). The addition of water in the fuel can globally cool the cylinder temperatures via the high latent heat of vaporization of water. In other words, as the water turns to steam, heat energy is absorbed which could otherwise contribute to the formation of NOx.

Alcohol fuels, including wet alcohol solutions, burn more cleanly compared to gasoline and diesel, and produce very low soot or particulate matter. Further, because alcohols are less complex, there tends to be lower unburnt hydrocarbons because the less complex molecules are able to more complete react. One aspect of the present disclosure generally relates to utilizing alcohol-water fuel mixtures to control the emissions of an internal combustion engine. More particularly, the instant disclosure provides methods and systems for providing a controlled ratio alcohol-based fuel to an internal combustion engine to reduce engine emissions.

The method can include monitoring an engine's emissions at the exhaust manifold to establish baseline engine emissions. The results from the monitoring can be provided to an engine control module (ECM) which can be configured to adjust one or more parameters of the engine, such as fuel injection, ignition timing, valve timing, boost pressure, or the like. The ECM can be pre-loaded with calibrated tables which can suggest increasing or decreasing the amount of water into the water/alcohol or non-fossil fuel mixture. Notably, it is the adjustment of water-to-alcohol, instead of increasing or decreasing water alone. As such, the method relies on the amount of water in the fuel as well as the fuel comprising alcohol to adjust the engine emissions.

In example, if the engine experiences an increase in load or other circumstances which increase the in-cylinder temperature, the formation of NOx is likely to increase. The method can comprise increasing the amount of water in the water/alcohol fuel to reduce the in-cylinder temperatures and lower the potential for the formation of NOx. Similarly, if the engine experiences a decrease in load or other circumstances which lower the in-cylinder temperature, the formation of CO or unburnt hydrocarbons can increase. The method can comprise decreasing the concentration of water in the fuel to increase cylinder temperature. It is noted that the fuel alone provides a substantial decrease in exhaust emissions, and the improvement of modulation of the ratio of water-to-alcohol can be operable to further decrease exhaust emissions.

Moreover, the disclosure provides an adaptive fuel management system which can be configured to modulate the ratio of water-to-alcohol in the fuel. It is contemplated that other components, such as DME, can also be incorporated to the non-fossil fuel and be modulated at a ratio to further control exhaust emissions. The adaptive fuel management system or ECU, responsive to the changing ratios in the fuel, can also adjust engine parameters, such as timing, boost, injection duration, etc. For example, if the engine increases the amount of water responsive to an increase in NOx emissions, the ECU or adaptive fuel management system can adjust any of the ignition timing, boost pressure (if force inducted), valve timing, fuel injection timing or duration, or the like to accommodate for the varying fuel. In some aspects, the air/fuel ratio of the engine can also be modulated to adjust the emissions species. Further, it is envisioned that the control of the dissociation can be further operable to adjust engine emissions.

### Method of Operating an Internal Combustion Engine

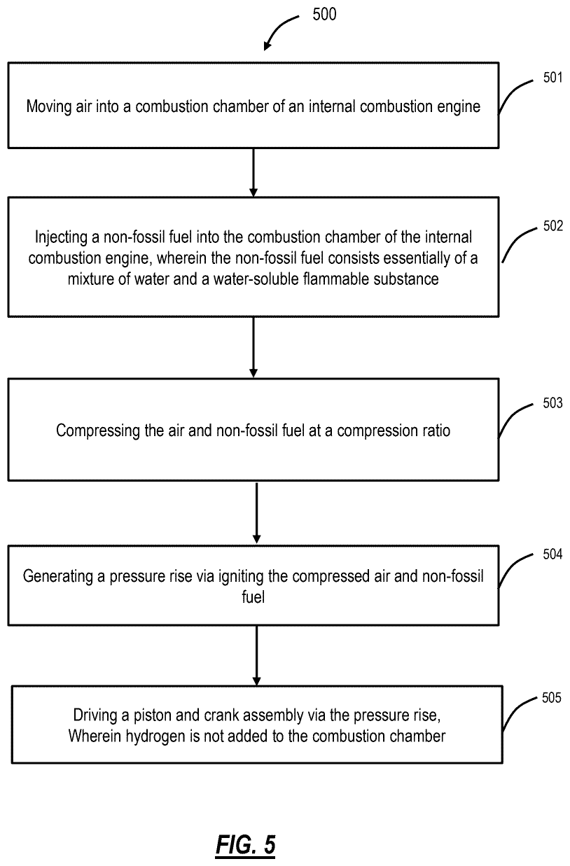

Turning now to FIG. 5, a method 500 for operating an internal combustion engine is shown and described. The method 500 can include moving air into a combustion chamber of an internal combustion engine 501. The method can comprise injecting a non-fossil fuel into the combustion chamber of the internal combustion engine, wherein the non-fossil fuel consists essentially of a mixture of water and a water-soluble flammable component 502. The method can include compressing the air and non-fossil fuel at a compression ratio 503. The method can comprise generating a pressure rise via igniting the compressed air and non-fossil fuel 504. The method can include driving a piston and crank assembly via the pressure rise, wherein hydrogen is not added to the combustion chamber 505.

The method 500 can include wherein the flammable component is an organic compound selected from a group consisting of an alcohol, an aldehyde, an acetone, Dimethyl Ether, or a combination of any of the foregoing organic compounds. Notably, other additives may be added, or the flammable component can include a combination of flammable components, such as a combination of alcohol and Dimethyl Ether. The method can include wherein flammable component is an alcohol selected from isopropyl alcohol, isobutyl alcohol, propyl alcohol, butyl alcohol, ethyl alcohol, methyl alcohol, a long chain alcohol, or a combination of any two or more of the foregoing alcohols. It should be noted that the foregoing is not a limiting list, and a person of ordinary skill in the art will recognize the effectiveness of various types of alcohols. For example, long chain alcohols may be used.

The method can include wherein the flammable component forms about 5% to 60% volume percent of the non-fossil fuel. The method can further include wherein the flammable components forms about 32% to 33% volume percent of the non-fossil fuel. Notably, the method can include varying the ratio of flammable components. The varying can be based on feedback from the engine. For example, the engine can receive input based on cylinder temperate to modulate the ratio of the flammable component of the non-fossil fuel.

The method can comprise modifying an engine to increase the compression ratio, either dynamically or statically. For example, the method can comprise modulating boost pressure to increase the pressure ratio, effective compression, or the like. The method can include raising the compression ratio via mechanical modification, such as machining the head. The compression ratio can be varied between about 15:1 to 40:1. The method can include wherein the compression ratio is about 10:1 to 40:1.

The method can include preheating the non-fossil fuel to above ambient temperatures. For example, the fuel can be heated via an external heat source, such as a heat exchanger. The method can include wherein the non-fossil fuel is preheated above ambient temperature prior to the injection to between about 60 degrees to 80 degrees Celsius. The non-fossil fuel can be injected into the engine. The method can include wherein the injection further comprises injecting the non-fossil fuel at a pressure in the range of about 200 psi to 10,000 psi.

The method can include selecting a non-fossil fuel with a ratio of flammable component to water such that, when the combustion chamber reaches an equilibrium state, causes the combustion chamber to operate at a predefined temperature, a predefined pressure, or both. The method can include modulating the ratio of the water and the flammable component of the non-fossil fuel to control any of combustion temperature, flame front speed, latent heat of vaporization, pressure rise, disassociation of Hydrogen and Oxygen from the water component, and specific emissions species formation. The method can include reducing one or more of Oxides of Nitrogen (NOx), Carbon Monoxide (CO), Carbon Dioxide (CO2) or Unburnt Hydrocarbons (UHC) based on the modulation of the ratio. The method can include wherein a percentage of the water component in the non-fossil fuel is operating to prolong a cylinder pressure delta prior to the ignition to increase the mean effective pressure at such time that the crank assembly is positioned for higher mechanical advantage. The method can include wherein the engine is configured to operate with HCCI or lean burn strategies.

### CONCLUSION

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing might be beneficial. Furthermore, the separation of system components described should not be interpreted as mandatory for all implementations, as the program components and systems can be integrated into a single software product or distributed across multiple software products.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

1. A method of generating power using an internal combustion engine capable of utilizing a non-fossil fuel, comprising:
moving air into a combustion chamber of the internal combustion engine; injecting a non-fossil fuel into the combustion chamber of the internal combustion engine, wherein the non-fossil fuel consists essentially of a mixture of water and a water-soluble flammable component;
modulating a ratio of the water to the water-soluble flammable component of the non-fossil fuel, responsive to an operating condition of the combustion engine, to control at least one of combustion temperature, pressure rise, dissociation of hydrogen and oxygen from the water, and specific emissions species formation:
compressing the air and non-fossil fuel at a compression ratio;
generating a pressure rise via igniting the compressed air fuel mixture; and
driving a piston and crank assembly via the pressure rise;
wherein hydrogen is not added to the combustion chamber.

2. The method of claim 1, wherein the flammable component is an organic compound selected from a group consisting of an alcohol, an aldehyde, an acetone, Dimethyl Ether, or a combination of any of the foregoing organic compounds.

3. The method of claim 2, wherein flammable component is an alcohol selected from isopropyl alcohol, isobutyl alcohol, propyl alcohol, butyl alcohol, ethyl alcohol, methyl alcohol, a long chain alcohol, or a combination of any two or more of the foregoing alcohols.

4. The method of claim 1, wherein the flammable component forms about 5% to 60% volume percent of the non-fossil fuel.

5. The method of claim 1, wherein the flammable component forms about 10% to about 30% volume percent of the non-fossil fuel.

6. The method of claim 1, wherein the compression ratio is about 10:1 to 40:1.

7. The method of claim 1, wherein the non-fossil fuel is preheated above ambient temperature prior to the injection to between about 60 degrees to 80 degrees Celsius.

8. The method of claim 1, wherein the injection further comprising injecting the non-fossil fuel at a pressure in a range of about 200 psi to 10,000 psi.

9. The method of claim 1, further comprising selecting a non-fossil fuel with a ratio of flammable component to water such that, when the combustion chamber reaches an equilibrium state, causes the combustion chamber to operate at a predefined temperature, a predefined pressure, or both.

10. The method of claim 1, further comprising modulating the ratio of the water and the flammable component of the non-fossil fuel to control any of combustion temperature, flame front speed, latent heat of vaporization, pressure rise, disassociation of Hydrogen and Oxygen from the water component, and specific emissions species formation.

11. The method of claim 10, further comprising reducing one or more of Oxides of Nitrogen (NOx), Carbon Monoxide (CO), Carbon Dioxide (CO2) or Unburnt Hydrocarbons (UHC) based on the modulation of the ratio.

12. The method of claim 1, wherein the compressing dissociates at least a portion of the water into hydrogen and oxygen within the combustion chamber prior to the igniting, and wherein steam rated from the water prolongs a cylinder pressure during an expansion stroke after the igniting to increase mean effective pressure while the crank assembly is positioned for higher mechanical advantage.

13. The method of claim 1, wherein the engine is configured to operate with homogeneous charge compression ignition (HCCI) strategy.

14. A vehicle having an internal combustion engine comprising:
at least one cylinder, each defining a combustion chamber;
an intake in fluid communication with each of the combustion chambers and configured to provide air thereto;
a fuel source configured to provide a non-fossil fuel consisting essentially of water and a water-soluble flammable component at a ratio into the combustion chambers, wherein the ratio is actively adjustable, the fuel source comprising a water source and a flammable-component source arranged to deliver variable relative so that the ratio is actively adjusted responsive to an operating condition of the internal combustion engine;
at least one piston configured for compression, gas exchange, and expansion in the at least one cylinder, configured to reciprocate therein, and coupled to a crank assembly configured to derive power from the piston; and
an ignition device configured to ignite a contents of the combustion chamber;
wherein the air and the non-fossil fuel are delivered at a ratio, compressed and ignited to generate a pressure rise against the piston.

15. The vehicle of claim 14, wherein the combustion chamber does not include hydrogen from a hydrogen source.

16. The vehicle of claim 14, wherein the ratio of water and non-fossil flammable component of the non-fossil fuel is actively adjusted to control combustion parameters.

17. The vehicle of claim 14, wherein the non-fossil fuel is preheated and injected into the combustion chamber or intake.

18. An internal combustion engine configured for power generation, comprising:
at least one cylinder, each defining a combustion chamber;
an intake in fluid communication with the combustion chambers and configured to provide air thereto;
a fuel source configured to provide a non-fossil fuel consisting essentially of water and a water-soluble flammable component at a ratio into the combustion chamber, wherein the ratio is actively adjustable, the fuel source comprising a water source and a flammable-component source arranged to deliver variable relative flows so that the ratio is actively adjusted responsive to an operating condition of the internal combustion engine;
at least one piston configured for compression, gas exchange, and expansion in the at least one cylinder, configured to reciprocate therein, and coupled to a crank assembly configured to derive power from the piston; and
an ignition device configured to ignite a contents of the combustion chamber;
wherein the air and the non-fossil fuel are delivered at a ratio, compressed and ignited to generate a pressure rise against the piston.

19. The internal combustion engine of claim 18, wherein the combustion chamber does not include hydrogen from a hydrogen source.

20. The internal combustion engine of claim 18, wherein the ratio of water and non-fossil flammable component of the non-fossil fuel is actively adjusted to control combustion parameters.
